(19) United States
(12) Patent Application Publication
(10) Pub. No.: US 2008/0062210 A1
(43) Pub. Date: Mar. 13, 2008

(54) DRIVING DEVICE, DISPLAY APPARATUS HAVING THE SAME AND METHOD OF DRIVING THE DISPLAY APPARATUS

(76) Inventor: Seong-Il Kim, Cheonan-si (KR)

Correspondence Address: F. CHAU & ASSOCIATES, LLC, 130 WOODBURY ROAD, WOODBURY, NY, 11797, US

(21) Appl. No.: 11/778,375

(22) Filed: Jul. 16, 2007

(30) Foreign Application Priority Data
Aug. 7, 2006 (KR) 10-2006-74293

(51) Int. Cl. G09G 5/10

(52) U.S. Cl. 345/691; 345/89

(57) ABSTRACT

In a driving device, a display apparatus having the driving device and a method of driving the driving device, a timing controller outputs a present image data during a first period within one frame and sequentially outputs a gray data having a lower gray-scale than a previous image data and a black data having a black gray-scale during a remaining second period. A data driving circuit changes the present image data into a present pixel voltage to output the present pixel voltage during the first period. Then, the data driving circuit sequentially receives the gray data and the black data and changes the gray data and the black data into a gray voltage and a black voltage to output the gray voltage and the black voltage. Thus, the display apparatus may prevent deterioration of brightness and eliminate blurring of moving images.

### CROSS-REFERENCE TO RELATED APPLICATION

This application relies for priority upon Korean Patent Application No, 2006-74293 filed on Aug. 7, 2006, the contents of which are herein incorporated by reference in its entirety.

### BACKGROUND OF THE INVENTION

1. Technical Field

The present disclosure relates to a driving device, a display apparatus having the driving device and a method of driving the display apparatus. More particularly, the present disclosure relates to a driving device capable of improving the visibility of moving images, a display apparatus having the driving device and a method of driving the display apparatus.

2. Discussion of Related Art

In general, a liquid crystal display apparatus is driven in a hold driving method to display an image signal, whereas a cathode ray tube display apparatus is driven in an impulsive driving method to display an image signal. When moving images are displayed on a liquid crystal display apparatus, a blurring phenomenon known as image tailing occurs on a screen due to a response speed of a liquid crystal.

In order to alleviate such blurring of moving images in a conventional liquid crystal display apparatus, a black data method, which applies image data to pixels and then applies a black data to the pixels during a black period corresponding to a predetermined portion within one frame, has been tried. The black data method, however, causes a deterioration of the brightness of the moving images displayed on a liquid crystal display apparatus.

Thus, to avoid the deterioration of brightness, a conventional liquid crystal display apparatus employs a gray-scale impulsive driving method that applies a lower gray-scale than a gray-scale of the image data during a black period. The gray-scale impulsive driving method determines a gray-scale corresponding to a black period of a present frame using gray-scale information of the image data of a previous frame.

The brightness of a liquid crystal display apparatus that employs the gray-scale impulsive driving method has been improved, however, the blurring (image tailing) phenomenon of the moving images is more severely deteriorated than that of the black data method.

### SUMMARY OF THE INVENTION

Exemplary embodiments of the present invention provide a driving device capable of improving brightness while removing a blurring phenomenon.

Exemplary embodiments of the present invention also provide a display apparatus having the above driving device.

Exemplary embodiments of the present invention also provide a method of driving the display apparatus.

In an exemplary embodiment of the present invention, a driving device includes a timing controller, a data driving circuit and a gate driving circuit.

The timing controller receives present image data and a control signal from an external device, outputs the present image data, a first control signal and a second control signal during a first period within one frame and sequentially outputs a gray data that has a lower gray-scale value than, the previous image data and black data that has a black gray-scale during a remaining second period of the frame. The data driving circuit changes the present image data into a present pixel voltage during the first period in response to the first control signal in order to output the present pixel voltage, sequentially receives the gray data and the black data to change the gray data and the black data into a gray voltage and a black voltage, respectively, and outputs the gray voltage and the black voltage doling the second period. The gate driving circuit outputs a gate signal including a first gate pulse generated during the first period and a second gate pulse generated during the second period in response to the second control signal.

In an exemplary embodiment of the present invention, a display apparatus includes a timing controller, a data driving circuit, a gate driving circuit and a display panel.

In the display apparatus, the timing controller receives present image data and a control signal from an external device, outputs the present image data, a first control signal and a second control signal during a first period within one frame and sequentially outputs gray data that has a lower gray-scale value than a previous image data and black data that has a black gray-scale during a remaining second period of the frame. In the display apparatus, the data driving circuit changes the present image data into a present pixel voltage in order to output the present pixel voltage during the first period in response to the first control signal, sequentially receives the gray data and the black data to change the gray data and the black data into a gray voltage and a black voltage, respectively, and outputs the gray voltage and the black voltage daring the second period. In the display apparatus, the gate driving circuit outputs a gate signal including a first gate pulse generated during the first period and a second gate pulse generated during the second period in response to the second control signal.

The display panel receives the pixel voltage to display an image in response to the first gate pulse during the first period and sequentially receives the gray voltage and the black voltage to sequentially lower the image to the black gray-scale in response to the second gate pulse during the second period.

In an exemplary embodiment of the present invention, a method of driving a display apparatus is provided as follows. When present image data and a control signal are input from an external device, the present image data, a first control signal and a second control signal are output during a first period within one frame. The present image data is changed into a present pixel voltage during the first period in response to the first control signal, and a first gate pulse is output during the first period in response to the second control signal. Thus, an image corresponding to the pixel voltage is displayed in response to the first gate pulse.

Then, gray data having a lower gray-scale value than the previous image data and a black data having a black gray-scale are sequentially output during a remaining second period within the one frame. When the gray data and the black data are sequentially input during the second period, the gray data and the black data are changed into a gray voltage and a black voltage, respectively, and a second gate pulse is output during the second period. The gray voltage and the black voltage are sequentially received in response to the second gate pulse, and the image is sequentially lowered to the black gray-scale.

According to the above, one or more gray data having a lower gray-scale value than the present image data are sequentially output during a predetermined period within one frame, and then black data having a black gray-scale value is outputted, thereby preventing deterioration of brightness and reducing a blurring (image-tailing) phenomenon efficiently.

### BRIEF DESCRIPTION OF THE DRAWINGS

Exemplary embodiments of the present invention will be understood in more detail from the following descriptions taken in conjunction with the accompanying drawings, in which;

FIG. 1 is a block diagram showing an exemplary embodiment of a driving device according to the present invention;

FIG. 2 is a graph showing gray-scale variations of data output from a timing controller shown in FIG. 1;

FIG. 3 is a waveform, diagram of first to n-th gate signals output from a gate driving circuit shown in FIG. 1;

FIG. 4 is a block diagram showing a liquid crystal display apparatus according to an exemplary embodiment of the present invention; and

FIG. 5 is a graph showing voltage variations charged into a liquid crystal capacitor shown in FIG. 4.

### DETAILED DESCRIPTION OF EXEMPLARY EMBODIMENTS

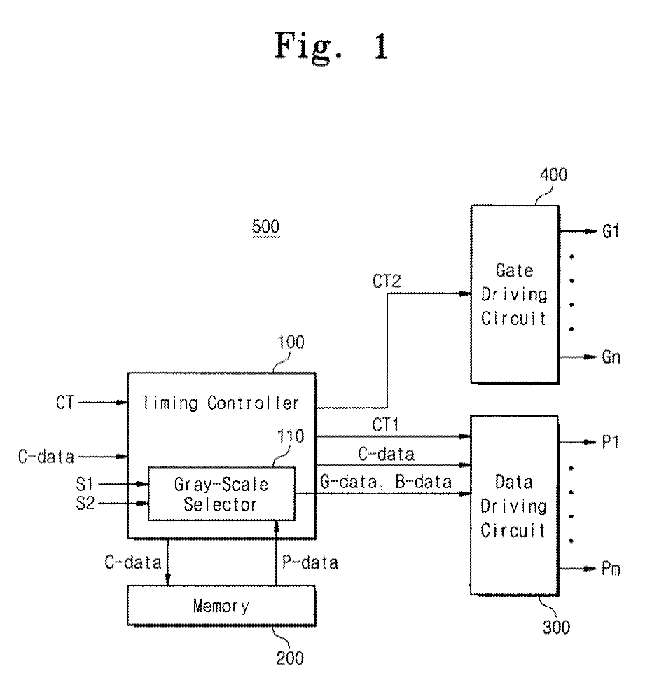

FIG. 1 is a block diagram showing an exemplary embodiment of a driving device according to the present invention.

Referring to FIG. 1, a driving device 500 includes a timing controller 100, a memory 200, a data driving circuit 300, and a gate driving circuit 400.

The timing controller 100 receives various control signals CT and present image data denoted as C-data from an external device. The timing controller 100 generates a first control signal CT1 and a second control signal CT2 based on the various control signals CT.

The timing controller 100 outputs the present image data C-data during a first period within one frame and sequentially outputs gray data denoted as G-data having a lower gray-scale value than the previous image data P-data and black data denoted as B-data having a black gray-scale value during a remaining second period within the one frame.

The memory 200 sequentially stores image data in one-frame units. More specifically, when the previous image data P-data is read out by the timing controller 100, the timing controller 100 writes in the present image data C-data to the memory 200.

The timing controller 100 includes a gray-scale selector 110 receiving the previous image data P-data that is read out from the memory 200. The gray-scale selector 110 outputs the gray data G-data in response to a first selection signal S1 during a gray period within the second period and outputs the black data B-data in response to a second selection signal S2 during a black period within the second period.

The data driving circuit 300 changes the present image data C-data into present pixel voltages P1˜Pm in response to the first control, signal CT1 during the first period and outputs the changed present pixel voltages P1˜Pm. The data driving circuit 300 sequentially receives the gray data G-data and the black data B-data during the second period and changes the gray data G-data and the black data B-data into a gray voltage and a black voltage to output the gray voltage and the black voltage.

The gate driving circuit 400 outputs first to n-th gate signals G1˜Gn in response to the second control signal CT2, and each of first to n-th gate signals G1˜Gn includes a first gate pulse output during the first period and a second gate pulse output during the second period.

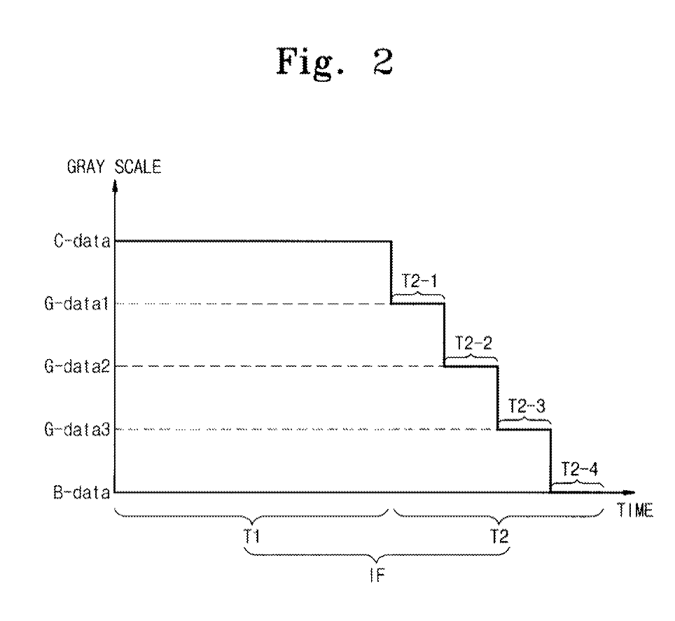

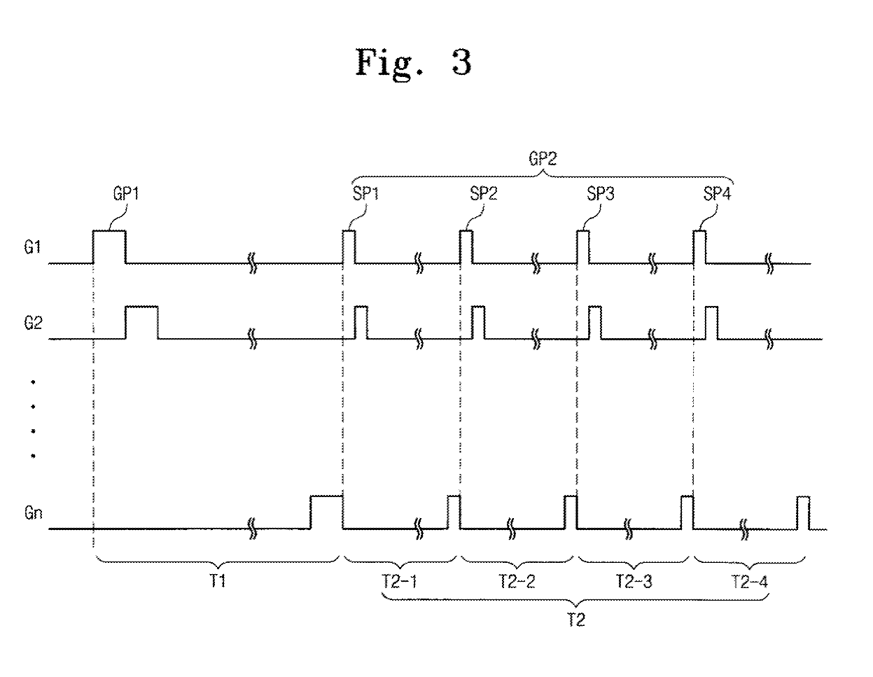

FIG. 2 is a graph showing gray-scale variations of data output from a timing controller shown in FIG. 1, and FIG. 3 is a waveform diagram of first to n-th gate signals output from a gate driving circuit shown in FIG. 1.

Referring to FIG. 2, the timing controller 100 (shown in FIG. 1) outputs the present image data C-data having a first gray-scale value during the first period T1 within the one frame 1F. Then, the timing controller 100 sequentially outputs first, second and third gray data G-data1, G-data2 and G-data3 having first to third gray gray-scale values, respectively, and the black data B-data having the black gray-scale during the remaining second period T2 within the one frame 1F.

In the exemplary embodiment, the second period T2 has a width that is equal to or less than that of the first period IT and is divided into four periods, first, second and third gray periods T2-1, T2-2 and T2-3 and a black period T2-4. The first to third gray-periods T2-1˜T2-3 have the same width and the black period T2-4 also has the same width as the first, second and third gray periods T2-1, T2-2 and T2-3.

Hereinafter, a case in which the previous image data P-data (see FIG. 1) have the same gray-scale value as the gray-scale value of the present image data C-data will be described.

The timing controller 100 outputs the first gray data G-data1 having a first gray-scale value that is lower than the first gray-scale value of the present image data C-data during the first gray period T2-1. Then, the timing controller 100 outputs the second gray data G-data2 having a second gray-scale value that is lower than the first gray-scale value during the second gray period T2-2. Subsequently, the timing controller 100 outputs the third gray data G-data3 having a third gray-scale value that is lower than the second gray-scale value during the third gray period T2-3. Then, the timing controller 100 outputs the black data B-data having the black gray-scale during the black period T2-4.

In the exemplary embodiment, the first gray data G-data 1 has a three fourths gray-scale value of the first gray-scale value, the second gray data G-data2 has a two fourths gray-scale value of the first gray scale value and the third gray data G-data3 has a one fourth gray-scale value of the first gray-scale value.

Referring to FIG. 3, the gate driving circuit 400 (shown in FIG. 1) sequentially outputs the first to n-th gate signals G1˜Gn. Each of the first to n-th gate signals G1˜Gn includes a first gate pulse GP1 and a second gate pulse GP2.

The first gate pulse GP1 is output during the first period T1 within the one frame 1F and the second gate pulse GP2 is output during the remaining second period T2 within the one frame 1F. The second gate pulse GP2 includes first to fourth sub gate pulses SP1, SP2, SP3 and SP4 output during the first to third gray periods T2-L T2-2, T2-3 and the black period T2-4, respectively, within the second period T2.

As shown in the FIGS. 2 and 3, when the first gate pulse GP1 is output during the first period T1, the data driving circuit 300 (shown in FIG. 1) changes the present image data C-data from the timing controller 100 into the pixel voltages P1˜Pm and outputs the changed pixel voltages P1˜Pm.

When the first sub gate pulse SP1 is output during the first gray period T2-1 within the second period T2, the data driving circuit 300 changes the first gray data G-data1 from the timing controller 100 into a first gray voltage and outputs the first gray voltage. Then, when the second sub gate pulse SP2 is output dining the second gray period T2-2, the data driving circuit 300 changes the second gray data G-data2 from the timing controller 100 into a second gray voltage and outputs the second gray voltage. Subsequently, when the third gate pulse SP3 is output during the third gray period T2-3, the data driving circuit 300 changes the third gray data G-data3 from the timing controller 100 into a third gray voltage and outputs the third gray voltage. Then, when the fourth sub gate pulse SP4 is output during the black period T2-4, the data driving circuit 300 changes the black data B-data from the timing controller 100 into a black voltage and outputs the black voltage.

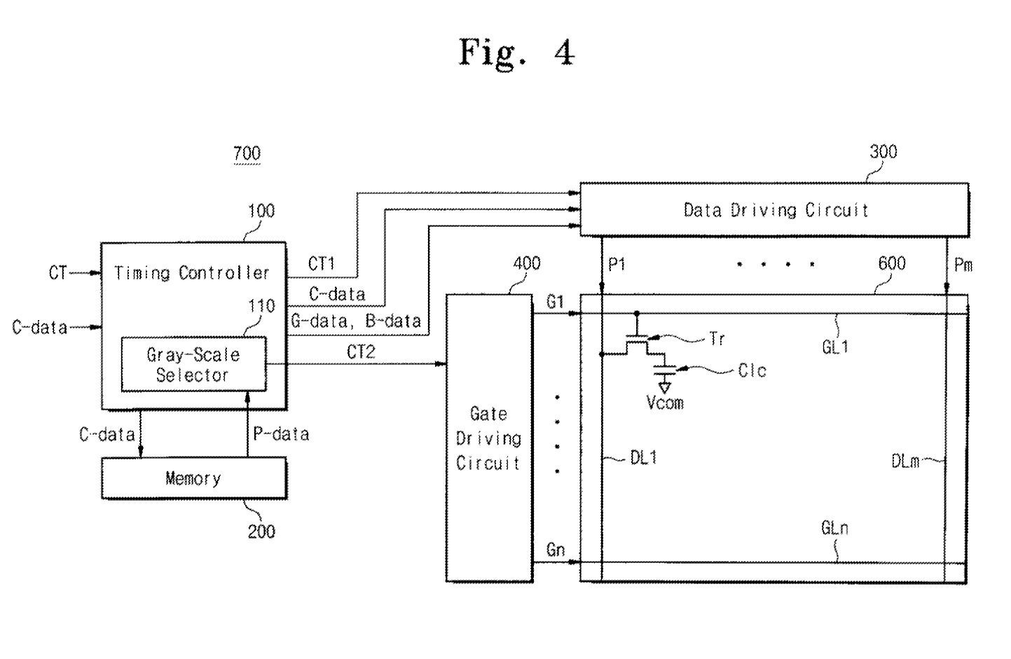

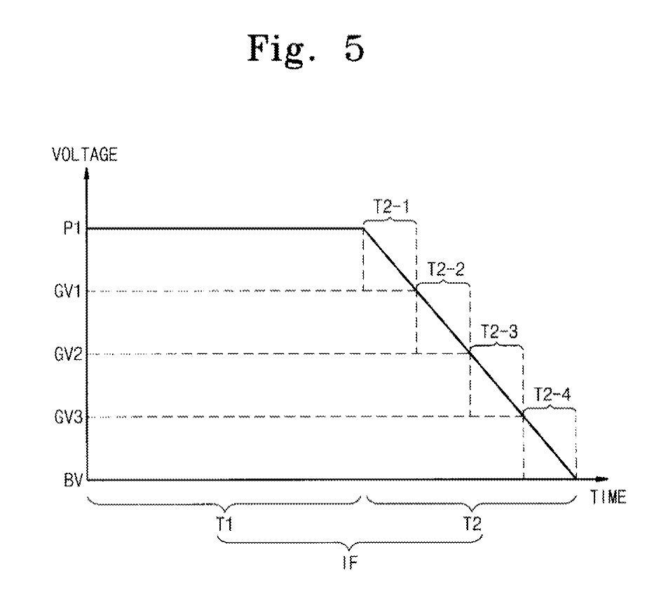

FIG. 4 is a block diagram showing a liquid crystal display apparatus according to an exemplary embodiment of the present invention, and FIG. 5 is a graph showing voltage variations charged into a liquid crystal capacitor shown in FIG. 4. In FIG. 4, the same reference numerals denote the same elements as in FIG. 1 and, thus, the detailed description of the same elements will be omitted.

Referring to FIG. 4, a liquid crystal display apparatus 700 includes a timing controller 100, a memory 200, a data driving circuit 300, a gate driving circuit 400 and a liquid crystal display panel 600.

The liquid crystal display panel 600 includes first to m-th data lines DL1˜DLm and first to n-th gate lines GL1˜GLn. The first to m-th data lines DL1˜DLm are electrically connected to the data driving circuit 300 to receive first to m-th pixel voltages P1˜Pm from the data driving circuit 300. The first to n-th gate lines GL1˜GLn are electrically connected to the gate driving circuit 400 to receive first to n-th gate signals G1˜Gn sequentially output from the gate driving circuit 400.

The first to m-th data lines DL1˜DLm are insulated from and intersected with the first to n-th gate lines GL1˜GLn to define a plurality of pixel areas on the liquid crystal display panel 600 in a matrix configuration. Each of the pixel areas includes a thin film transistor Tr and a liquid crystal capacitor Clc. In the exemplary embodiment, the thin film transistor Tr formed in a first pixel area includes a gate electrode connected to the first gate line GL1, a source electrode connected to the first data line DL1 and a drain electrode connected to a first end of the liquid crystal capacitor Clc. A common voltage Vcom is applied to the other end of the liquid crystal capacitor Clc.

When the first gate signal GS1 is applied to the first gate line GL1, the first pixel voltage P1 is applied to the first end of the liquid crystal capacitor Clc through the thin film transistor Tr, Thus, the liquid crystal capacitor Clc is charged by an electric potential difference between the first pixel voltage P1 and the common voltage Vcom.

As shown in FIG. 5, assuming that the common voltage Vcom is 0V, the first pixel voltage P1 is charged into the liquid crystal capacitor Clc during a first period T1 within one frame 1F, Then, first to third gray voltages GV1 GV2 and GV3 are sequentially applied to the first end of the liquid crystal capacitor Clc during first, second and third gray periods T2-1, T2-2 and T2-3, and a black voltage BV is applied to the first end of the liquid crystal capacitor Clc during a black period T2-4 within a remaining second period T2 of the one frame 1F.

Although the first to third gray voltages GV1. GV2 and GV3 and the black voltage BV are applied to the first end of the liquid crystal capacitor Clc, the voltage charged into the liquid crystal capacitor Clc is continuously varied as shown by the solid line in FIG. 5.

According to the exemplary embodiment, during the predetermined period within the one frame, one or more gray data having a gray-scale value lower than the present image data are sequentially output and the black data having the black gray-scale is finally output.

Thus, deterioration of the brightness may be prevented and the blurring (image-tailing) phenomenon of the moving images may be substantially reduced, so that the liquid crystal display apparatus may have an improved visibility when displaying moving images thereon.

Although exemplary embodiments of the present invention have been described, it is understood that the present invention should not be limited to these exemplary embodiments but various changes and modifications can be made by one of ordinary skill in the art within the spirit and scope of the present invention, as hereinafter claimed.

What is claimed is:

1. A driving device comprising:
a timing controller receiving a present image data and a control signal from an external device and outputting a first control signal and a second control signal outputting the present image data during a first period within one frame, and sequentially outputting gray data that has a lower gray-scale value than previous image data and black data that has a black gray-scale value during a remaining second period within the one frame;
a data driving circuit changing the present image data into a present pixel voltage and outputting the present pixel voltage during the first period in response to the first control signal sequentially receiving the gray data and the black data to change the gray-data and the black data into a gray voltage and a black voltage, respectively, and outputting the gray voltage and the black voltage during the second period; and
a gate driving circuit outputting a gate signal including a first gate pulse generated during the first period and a second gate pulse generated during the second period in response to the second control signal.

2. The driving device of claim 1, wherein the second period comprises a gray-period during which the gray data is output and a black period during which the black data is output.

3. The driving device of claim 2, wherein the gray data comprise a plurality of sub gray data, each of which has a gray-scale value that becomes sequentially lower than the previous image data.

4. The driving device of claim 3, wherein the gray period comprises a plurality of sub gray periods during which, the plurality of sub gray data are output according to an order of the gray-scale value, and the sub gray periods all have a same width.

5. The driving device of claim 4, wherein the black period has a same width as the width of each of the sub gray periods.

6. The driving device of claim 3, wherein the gray data have a gray-scale difference between each other corresponding to a predetermined gray-scale value.

7. The driving device of claim 1, wherein the second period has a width that is equal to or less than a width of the first period.

8. The driving device of claim 1, wherein the timing controller comprises a gray-scale selector outputting the gray data in response to a first selection signal during the gray period within the second period and outputting the black data in response to a second selection signal during the black period within the second period.

9. The driving device of claim 8, further comprising a memory sequentially storing image data in one frame units.

10. A display apparatus comprising:
a timing controller receiving present image data and a control signal from an external device and outputting a first control signal and a second control signal, outputting the present image data during a first period within one frame and sequentially outputting gray data that has a lower gray-scale value than previous image data and black data that has a black gray-scale value during a remaining second period within the one frame;
a data driving circuit changing the present image data into a present pixel voltage and outputting the present pixel voltage during the first period in response to the first control signal, sequentially receiving the gray data and the black data to change the gray data and the black data into a gray voltage and a black voltage, respectively, and outputting the gray voltage and the black voltage during the second period;
a gate driving circuit outputting a gate signal including a first gate pulse generated during the first period and a second gate pulse generated during the second period in response to the second control signal; and
a display panel receiving the pixel voltage to display an image in response to the first gate pulse during the first period and sequentially receiving the gray voltage and the black voltage to sequentially lower the image to the black gray-scale value in response to the second gate pulse during the second period.

11. The display apparatus of claim 10, wherein the timing controller comprises a gray-scale selector outputting the gray data in response to a first selection signal during the gray period within the second period and outputting the black data in response to a second selection signal during the black period within the second period.

12. The display apparatus of claim TL further comprising a memory sequentially storing image data in one frame units.

13. The display apparatus of claim 10, wherein the second period comprises a gray period during which the gray data are output and a black period during which the black data are output.

14. The display apparatus of claim 13, wherein the gray data comprise a plurality of sub gray data, each of which has a gray-scale value that becomes sequentially lower than the previous image data.

15. The display apparatus of claim 14, wherein the gray period comprises a plurality of sub gray periods during which the plurality of sub gray data are output according to an order of the gray-scale.

16. A method of driving a display apparatus comprising;
receiving present image data and a control signal from an external device and outputting the present image data, a first control signal and a second control signal during a first period within one frame;
changing the present image data into a present pixel voltage during the first period in response to the first control signal;
outputting a first gate pulse during the first period in response to the second control signal;
displaying an image corresponding to the pixel voltage in response to the first gate pulse;
sequentially outputting gray data having a lower gray-scale value than a previous image data and black data having a black gray-scale value during a remaining second period within the one frame;
sequentially receiving the gray data and the black data during the second period to change the gray data and the black data into a gray voltage and a black voltage;
outputting a second gate pulse during the second period; and
sequentially receiving the gray voltage and the black voltage in response to the second gate pulse to sequentially lower the image to the black gray-scale.

17. The method of claim 16, wherein the second period is divided into a gray period outputting the gray data and a black period outputting the black data.

18. The method of claim 17, wherein the gray data comprise a plurality of sub gray data each which has a gray-scale that becomes sequentially lower than the previous image data.

19. The method of claim 18, wherein the gray period comprises a plurality of sub gray periods during which the plurality of sub gray data are output according to an order of the gray-scale.
